(19) United States
(12) Patent Application Publication
(10) Pub. No.: US 2009/0089390 A1
(43) Pub. Date: Apr. 2, 2009

(54) Method and System in a Multicomputer Data Transferring Environment for Scheduling Message Sending Using Communication Devices

(76) Inventors: Gene S. Fein, Lenox, MA (US); Edward Merritt, Lenox, MA (US)

Correspondence Address: MCDONNELL BOEHNEN HULBERT & BERGHOFF LLP, 300 S. WACKER DRIVE, 32ND FLOOR, CHICAGO, IL, 60606, US

(21) Appl. No.: 11/863,558

(22) Filed: Sep. 28, 2007

(51) Int. Cl. G06F 15/16

(52) U.S. Cl. 709/207

(57) ABSTRACT

A computer implemented method for transferring sender-to-recipient data in a multicomputer environment in response to priority characteristics of the data comprises the computer implemented steps of determining a message to be sent using a communication device and scheduling sending the message using the communication device. Scheduling sending the message can comprise one or more computer implemented steps the communication device can take on the message. The computer implemented method can allow recipient-specific or content-specific rules to be applied to a message to be sent to one or more recipients using the communication device. System and computer program products that can be used to perform methods of the present invention are also provided.

### BACKGROUND OF THE INVENTION

It is well known that electronic communication devices can be used to generate, send, receive and store messages. Devices such as the Windows Mobile® devices (Windows Mobile® is a registered trademark of Microsoft Corporation, Redmond, Wash.) and the iPhone (manufactured by Apple Incorporation, Cupertino, Calif.) have combined media players, digital camera capabilities and other features with communication functions into a single device. These devices are constantly evolving, with more and more features and user interfaces added into new software versions and new hardware products. Messages that can be generated, sent, received and stored in these devices are no longer limited to texts, but have expanded to include messages with image, voice and even video contents. Larger and larger memory and storage space make it possible to store received, sent and drafted messages in higher volumes and sizes than ever before. Sending messages to more than one person (recipient) at a time using multiple primary addresses and sending copies of messages to recipients using Carbon copy (Cc) or Blind carbon copy (Bcc) have also become typical functions for mobile devices.

Most electronic communication service providers, e.g. wireless carriers, telephone companies and cable companies, bill users on a monthly basis. Even though some high-priced service plans allow unlimited voice communication and/or data transmission, most service plans divide a day into “peak” hours and “off-peak” hours, wherein for a basic monthly fee, users can use the voice and/or data network for free or at a lower service rate during off-peak hours, and use the voice and/or data network for a maximum number of minutes per month for free during peak hours. Some low-cost plans do not even have any time period when user can use the voice and/or data network for free at all, but limit the total use of the network to a certain maximum number of minutes. In those plans where there is an upper limit of minutes, any use of the network for longer than the limit during the time periods when the limit applies would incur additional high service charges. This situation is especially common for wireless communication services. In light of the high and ever increasing volumes and sizes of messages that can be generated, sent, received and stored in electronic communication devices nowadays, and the relatively constant or even increasing costs of data transmission charged by electronic communication service providers, there is a need to efficiently schedule the timing when messages are being transmitted in order to avoid unexpected and/or undesirable billing.

### SUMMARY OF THE INVENTION

The present invention relates to method and system for data transferring in a multicomputer environment. The data transferring between multiple computers is related to the transferring of messages using communication devices in a sender-to- recipient manner in response to priority characteristics of the messages. Computer program products that can be used to perform methods of the present invention are also provided.

According to one aspect of the present invention, a computer implemented method for transferring sender-to-recipient data in a multicomputer environment in response to priority characteristics of the data comprises the computer implemented steps of determining a message to be sent using a communication device and scheduling sending the message using the communication device. The message can comprise audio information, or visual information, or a combination thereof. The audio information can comprise any audible sound, including voice, and the visual information can comprise any text, still image or video, or any combination thereof. The communication device can comprise any of wired and wireless telephones, online computer systems, cable systems, and other devices utilizing wired or wireless networks. The wired or wireless networks can comprise any of cellular networks, cable networks, telephone lines, Wi-Fi networks, Bluetooth networks and optical fiber networks. Scheduling sending the message can comprise at least one of the computer implemented steps of: a) sending the message once immediately; b) sending the message once at a first later time; c) sending the message at a first series of recurring times starting immediately; d) sending the message at a second series of recurring times starting at a second later time; e) sending the message at a time when the service rate is lowest; f) canceling sending the message; g) providing the user with a first reminder at a third later time; and h) providing the user with a second reminder at a third series of recurring times starting at a fourth later time, wherein step f) is not taken together with any other step, and at least one of the steps b), c), d), e), g) and h) is taken.

The method can further comprise at least one of the computer implemented steps of determining at least one of the first later time, the second later time, the third later time and the fourth later time; determining the number of recurring times in at least one of the first series of recurring times, the second series of recurring times and the third series of recurring times; determining the intervals between the recurring times in at least one of the first series of recurring times, the second series of recurring times and the third series of recurring times; and determining at least one of the first reminder and the second reminder. The intervals can be any of consistent intervals, incremental intervals and decremental intervals. At least one of the first reminder and the second reminder can comprise prompts that can allow the user to specify one or more actions the communication device can take on the message. The one or more actions that the user can specify when prompted by at least one of the first reminder and the second reminder can be any one or combination of: action I, sending the message to be sent once immediately; action II, sending the message to be sent once at a fifth later time; action III, sending the message to be sent at a fourth series of recurring times starting immediately; action IV, sending the message to be sent at a fifth series of recurring times starting at a sixth later time; action V, sending the message to be sent at a second time when the service rate is lowest; action VI, canceling sending the message to be sent; action VII, providing the user with a third reminder at a seventh later time; and action VIII, providing the user with a fourth reminder at a sixth series of recurring times starting at an eighth later time, wherein action VI is not taken together with any other action.

The method can also further comprise the computer implemented step of determining the time when the service rate is lowest. The time when the service rate is lowest for the message can be a period during which the regular service rate to send the message is the lowest, if there are more than one period, each with a different regular service rate, according to a service plan. The time when the service rate is lowest for the message can alternatively be a time when a remaining balance for sending the message is above a threshold, irrespective of whether the time when the remaining balance for sending the message is above the threshold is during a period during which the regular service rate to send the message is the lowest, if there are more than one period, each with a different regular service rate, according to a service plan. The threshold can be determined either by default or as specified by the user. User specification can be given either upon prompt or in the absence of any prompt.

According to another aspect of the present invention, a computer implemented method for transferring sender-to-recipient data in a multicomputer environment in response to priority characteristics of the data comprises the computer implemented steps of: a) determining a message to be sent to one or more recipients using a communication device; b) for the message, determining any recipient with a recipient-specific rule associated therewith; c) scheduling sending the message to each recipient with a recipient-specific rule associated therewith using the communication device; and d) scheduling sending the message to each recipient without a recipient-specific rule associated therewith using the communication device. The message can comprise audio information, or visual information, or a combination thereof. The audio information can comprise any audible sound, including voice, and the visual information can comprise any text, still image or video, or any combination thereof. The communication device can comprise any of wired and wireless telephones, online computer systems, cable systems, and other devices utilizing wired or wireless networks. The wired or wireless networks can comprise any of cellular networks, cable networks, telephone lines, Wi-Fi networks, Bluetooth networks and optical fiber networks. Scheduling sending the message to each recipient with a recipient-specific rule associated therewith using the communication device can comprise any of the computer implemented steps of: i) proceeding as specified by the recipient-specific rule associated with the recipient; ii) specifying a new recipient-specific rule for the recipient and proceeding as specified by the new recipient-specific rule; and iii) sending the message to the recipient with a recipient-specific rule associated therewith not applying any recipient-specific rule. Scheduling sending the message to each recipient without a recipient-specific rule associated therewith using the communication device can comprise any of the computer implemented steps of: i) creating a recipient-specific rule for the recipient without a recipient-specific rule associated therewith and proceeding as specified by the recipient-specific rule created; and ii) sending the message to the recipient without a recipient-specific rule associated therewith not applying any recipient-specific rule. Sending the message to the recipient with or without a recipient-specific rule associated therewith not applying any recipient-specific rule can comprise sending the message to the recipient with or without a recipient-specific rule associated therewith applying a content-specific rule.

The method can further comprise the computer implemented step of storing one or more recipient-specific rules in the communication device.

At least one recipient-specific rule can comprise one or more actions the communication device can take on the message. The one or more actions can be any one or combination of: action I, sending the message to be sent once immediately; action II, sending the message to be sent once at a first later time; action III, sending the message to be sent at a first series of recurring times starting immediately; action IV, sending the message to be sent at a second series of recurring times starting at a second later time; action V, sending the message to be sent at a time when the service rate is lowest; action VI, canceling sending the message to be sent; action VII, providing the user with a first reminder at a third later time; and action VIII, providing the user with a second reminder at a third series of recurring times starting at a fourth later time, wherein action VI is not taken together with any other action.

According to still another aspect of the present invention, a computer implemented method for transferring sender-to-recipient data in a multicomputer environment in response to priority characteristics of the data comprises the computer implemented steps of: a) determining a message to be sent to one or more recipients using a communication device; b) for the message, determining any existing content-specific rule(s) that can be evoked; and c) scheduling sending the message to each recipient of the message using the communication device. The message can comprise audio information, or visual information, or a combination thereof. The audio information can comprise any audible sound, including voice, and the visual information can comprise any text, still image or video, or any combination thereof. The communication device can comprise any of wired and wireless telephones, online computer systems, cable systems, and other devices utilizing wired or wireless networks. The wired or wireless networks can comprise any of cellular networks, cable networks, telephone lines, Wi-Fi networks, Bluetooth networks and optical fiber networks. Scheduling sending the message to each recipient of the message using the communication device can comprise any of the computer implemented steps of: i) proceeding as specified by one of the content-specific rule(s) that can be evoked, if there is any; ii) creating a new content-specific rule irrespective of whether any existing content-specific rule(s) can be evoked, and proceeding as specified by the new content-specific rule; and iii) sending the message to be sent to the recipient not applying any content-specific rule, irrespective of whether any existing content-specific rule(s) can be evoked. Sending the message to the recipient not applying any content-specific rule can comprise sending the message to the recipient applying a recipient-specific rule.

The method can further comprise the computer implemented step of storing one or more content-specific rules in the communication device.

At least one content-specific rule can comprise one or more actions the communication device can take on the message. The one or more actions can be any one or combination of: action I, sending once immediately; action II, sending once at a first later time; action III, sending at a first series of recurring times starting immediately; action IV, sending at a second series of recurring times starting at a second later time; action V, sending at a time when the rate is lowest; action VI, canceling sending; action VII, providing the user with a first reminder at a third later time; and action VIII, providing the user with a second reminder at a third series of recurring times starting at a fourth later time, wherein action VI is not taken together with any other action.

According to yet another aspect of the present invention, a computer program product comprises a computer usable medium having a computer readable program for scheduling sending of sender-to-recipient messages using a communication device. For a given message to be sent using the communication device, the computer readable program when executed by a computer can cause the computer to take one or more of the following steps: a) send the given message once immediately; b) send the given message once at a first later time; c) send the given message at a first series of recurring times starting immediately; d) send the given message at a second series of recurring times starting at a second later time; e) send the given message at a time when the service rate is lowest; f) cancel sending the given message; g) provide the user with a first reminder at a third later time; and h) provide the user with a second reminder at a third series of recurring times starting at a fourth later time, wherein step f) is not taken together with any other step, and at least one of the steps b), c), d), e), g) and h) is taken.

According to yet another aspect of the present invention, a computer program product comprises a computer usable medium having a computer readable program for scheduling sending of sender-to-recipient messages using a communication device. The computer readable program when executed by a computer can cause the computer to: store one or more recipient-specific rules, or one or more content-specific rules, or both, in the communication device; determine for a given message to be sent to one or more recipients using the communication device, any recipient with a recipient-specific rule associated therewith, or any content that can evoke an existing content specific rule, or both; and schedule sending the given message to each recipient of the given message using the communication device, applying an existing recipient-specific rule, a new recipient-specific rule, an evoked content-specific rule, or a new content-specific rule, or not applying any recipient- or content-specific rules.

According to yet another aspect of the present invention, a system to transfer sender-to-recipient data in a multicomputer environment in response to priority characteristics of the data comprises a scheduler configured to determine one or more times when one or more actions are to be taken on a given message, a timing unit configured to generate and transmit, at the one or more times determined by the scheduler, one or more instructions to take the one or more actions, and a processor having a monitoring unit, the processor configured to take the one or more actions on the given message in response to the monitoring unit receiving the one or more instructions and in accordance with the one or more instructions received. The one or more actions can be any one or combination of: action I, send the message once immediately; action II, send the message once at a first later time; action III, send the message at a first series of recurring times starting immediately; action IV, send the message at a second series of recurring times starting at a second later time; action V, send the message at a time when the rate is lowest; action VI, cancel the sending of the message; action VII, provide to the user a first reminder at a third later time; and action VIII, provide to the user a second reminder at a third series of recurring times starting at a fourth later time, wherein action VI is not taken on the given message if any other action is taken.

### BRIEF DESCRIPTION OF THE DRAWINGS

The foregoing will be apparent from the following more particular description of example embodiments of the invention, as illustrated in the accompanying drawings. The drawings are not necessarily to scale, emphasis instead being placed upon illustrating embodiments of the present invention.

FIG. 1 is a block diagram of an exemplary “Smart Sender System” according to one embodiment of the present invention.

FIG. 2 is a flowchart illustrating an example of the basic processing of the Smart Sender System according to one embodiment of the present invention.

FIG. 3 is a flowchart illustrating an example of the basic processing of the Smart Sender System according to another embodiment of the present invention, when at least one recipient-specific rule or at least one content-specific rule or both are evoked.

FIG. 4 is a flowchart illustrating an example of the basic processing of the Smart Sender System according to yet another embodiment of the present invention, when action V is taken, i.e., when the “Smart Cash Saver” rule is evoked.

FIG. 5 is a flowchart illustrating an example of the deployment and execution process of the Smart Cash Saver software.

FIGS. 6A-B are drawings illustrating examples of displays on the screen of a cell phone according to two different embodiments of the present invention, when a user completes generation of a message and press “SEND.”

FIGS. 7A-B are drawings illustrating examples of displays on the screen of a personal digital assistant (PDA) according to two different embodiments of the present invention, when a user completes generation of a message and press “SEND.”

FIG. 8 is a schematic view of a computer environment in which the principles of the present invention may be implemented.

FIG. 9 is a block diagram of the internal structure of a computer from the FIG. 8 computer environment.

### DETAILED DESCRIPTION OF THE INVENTION

A description of example embodiments of the invention follows.

The teachings of all patents, published applications and references cited herein are incorporated by reference herein in their entirety.

The present invention relates to the creation of a system (also referred to herein as the “Smart Sender System”) that allows a communication device to cache messages until a time when rates are lowest, or until a designated time specified by default or by the user, before sending the cached messages in an automated manner to user-specified recipients. Software application embodying the system and user interface of the software application are also disclosed herein. The Smart Sender System saves the user financial resources and allows for pinpoint delivery of messages.

As used herein, “communication device” refers to any electronic communication device that can be used to generate, send, receive and store messages. Non-limiting examples of communication devices include wired and wireless telephones, online computer systems, cable systems, and other devices utilizing wired or wireless networks, the networks comprising any of cellular networks, cable networks, telephone lines, Wi-Fi networks, Bluetooth networks and optical fiber networks. Via proper user interface, known to those skilled in the art, a communication device can interact with its user by giving prompts to the user and receiving instructions from the user. With proper programming, known to those skilled in the art, a communication device can take certain actions as instructed by the user.

As used herein, “messages” refers to any information (also referred to herein as “content”) that can be generated, sent, received and stored in a communication device. Messages are intended for information transmission to others and refer to those pieces of information that can be sent by the user of a communication device to others, in a sender-to-recipient manner. Information contained in a message can be generally categorized into audio information and visual information. Audio information can contain any audible sound, including voice, the sound produced by the vocal organs of a vertebrate, especially a human being. Non-limiting examples of visual information include text, still image (e.g., drawings, pictures) and video (e.g., flash videos, movies). A message can contain one or more types of information. For example, a message can be audio-visual (e.g., containing both sound and video) and a video message can contain text in the form of subtitles. Messages can also contain one or more attachments. As used herein, “attachment” means a message contained in another message. An attachment can contain one or more types of information as a message does. However, an attachment typically does not contain any further attachment.

As used herein, “determining a message” comprises generating, identifying or selecting a message. Generating a message means to create a message. A message can be generated either de novo, or derived from existing information. For example, a message can be generated by editing an existing text file, or by combining an existing text file with an existing video file together (e.g., as attachments in the same message). Identifying a message means to recognize a message from a mixture of information comprising one or more messages and non-message information. Selecting a message means to choose a message from a plurality of messages.

As used herein, “cache” means a message is temporarily stored in a communication device's memory before it is sent out in an automated manner by the Smart Sender System from the communication device when the rates are lowest or when a designated time specified by the user is reached. As used herein, “memory” refers to any physical component of a communication device that can be used to temporarily or permanently store and/or manipulate data. Non-limiting examples of memory include random access memory (RAM), read-only memory (ROM), flash memory, internal and external hard drives of a computer, and any medium in which electronic data can be stored, e.g., magnetic tape, and CD and DVD optical discs. As used herein, “in an automated manner” means that a cached message is sent out by the Smart Sender System from a communication device when the rates are lowest or when a designated time specified by default or by the user is reached, in the absence of any instructions or intervention from the user immediately before or when the message is sent.

As used herein, “prompt” refers to any information a communication device can communicate to the user that requires the user's instruction. For example, a prompt can enable the user to select among different options, to input certain information, to provide approval or rejection of an action to be taken by the communication device or of an option selected, and to provide acknowledgment of an action taken by the communication device or of a system notification. Non-limiting examples of the forms of prompts a communication device can generate include audio prompts (e.g., voice prompts) and visual prompts (e.g. texts, images, and videos), prompts with any combination of audio and/or video forms, and any other attention-drawing functions of a communication device, e.g., ringer tones and vibration. The user can give instructions to the communication device by, for example, pressing buttons, typing on a keyboard, or by voice (voice command or activation).

As used herein, “action” (also referred to herein as “computer implemented step”) means any function that a communication device can perform, provided proper hardware and/or software. An action or a computer implemented step can be taken by the communication device either by default or as specified by the user. User specification, e.g., in the form of an instruction, can be given to the communication device either upon prompt, or in the absence of any prompt. Therefore, taking any action or computer implemented step described here in comprises taking the action or computer implemented step either by default or as specified by the user, wherein user specification is given either upon prompt or in the absence of any prompt. An action or a computer implemented step can be taken to generate a user-desirable result. For example, sending a message immediately after the user instructs the communication device to send the message is an action the communication device can take on the message. This remains the only action communication devices used in the industry and sold in the market can do to send a message, unless the user cancels sending the message, in which case, he or she has to give the “send” instruction again in order to have the message sent by the communication device.

As used herein, “by default” means a system-chosen setting unless the user specifies otherwise. Default settings can be preset by manufacturers when a communication device is manufactured, or by service providers before the communication device is sold to end users. Alternatively, default settings can be set by the user when the communication device or any relevant software application therein is used for the first time after purchase. Once the default settings are set up, they can be displayed whenever the user is prompted to give certain instructions, e.g., to specify a time or a balance threshold. The user can either accept the default setting, or specify a different setting. Default settings, especially those set up by the user when the communication device or any relevant software application therein is used for the first time after purchase, can be changed by the user at any time. Default settings can also be changed by the manufacturer or the service provider after the communication device is sold, for example, by way of a firmware update.

As used herein, “service rate” refers to the amount of money a communication service provider can charge per unit time of using the communication service it can provide (e.g., expressed as cents per minute), or to the amount of money the communication service provider can charge per unit volume of data transmitted using the communication service it can provide (e.g., expressed as cents per megabytes). Some service plans can designate different time periods during which the service rates are different (e.g., “peak hours” vs. “off-peak hours). Alternatively, service rate can be consistent for a given service plan. As used herein, “balance” refers to any form of indication of the amount of communication service (e.g., calling or data transmission) that can be used by a user at a certain service rate according to the user's service plan. Non-limiting examples of balance include cash deposit in the user account with the service provider, length of time (e.g., expressed as number of minutes) that the service can be used, and volume of data (e.g., expressed as megabytes) that can be transmitted. For a service plan with consistent service rate, there can be only one balance, which can be expressed in different ways as described above. For those service plans with different service rates during different periods, there can be a balance for each period. For example, according to certain service plans, for “unlimited calls” during “off-peak hours,” the balance is always unlimited, and for “peak hours” there is a maximal number of minutes allowed when the regular service rate applies. Any use of the service during this period can reduce the balance (minutes as described in this example), before a threshold balance, which can be either zero or positive, is reached. When a user's remaining balance for such a period, if there is one, is lower than the threshold specified by the service provider or is used up according to the service plan (e.g., the maximal number of minutes is used up), the service provider can either terminate the service provided to the user, or charge at a higher service rate for any further use of the service until there is a sufficiently large enough increase in the balance according to the service plan. Therefore, “regular service rate,” as used herein, refers to a service rate that regularly applies for a given period if the remaining balance during the given period is above a threshold designated by the service provider, below which threshold, higher service rate or termination of service can be applied. There are various methods known to those skilled in the art to increase balances. For example, for service plans with regular billing cycles, the balance for each period, if there are different periods with different service rates according to the service plan, can become full according to the service plan at the start of a new billing cycle. Alternatively, the user can increase the balance at any time by paying or requesting the service provider to do so, for example, in a pre-paid cell phone plan.

Communication devices used in the industry and for sale in the market nowadays address the generating, sending, receiving and storing of messages. Non-limiting examples of messages that can be stored in these devices include unsent messages (as drafts), sent messages, received messages and deleted messages (e.g., those that are placed in a “deleted items” folder or in a “recycle bin” and are still retrievable before the “deleted items” folder or the “recycle bin” is emptied). Received messages can be further categorized into unread and read messages. The existing uses of communication devices for transmitting messages have certain limitations in distribution, implementation, potential cost savings and deployment. For example, messages can only be stored in the device or sent immediately. To send a message, the user of the device has to provide the “send” instruction (e.g., by clicking the “SEND” button on a cell phone) immediately before the message is sent. Messages are not capable of being cached and then sent either at a specific time later, at recurring times later, upon prompt later, or at a time that is the least expensive based upon user calling, usage plan and associated charges.

The present invention solves these problems by providing an integrated system which can cache messages to be sent and send the messages at a time that is either set by default by the system or specified by the user to save system charges, or set by default or specified by the user based upon specific rules set by the user, preferably via a system menu. Additionally, system according to the present invention can cache messages to be sent and remind the user to send the messages via selectable prompts provided by the system to the user at default or user-specified times after the message has been cached.

According to one embodiment of the present invention, to schedule sending of sender-to-recipient messages using a communication device in response to the priority characteristics of messages, a message to be sent using the communication device is first determined. The message can comprise audio information, or visual information, or a combination thereof. The audio information can comprise any audible sound, including voice, and the visual information can comprise any text, still image or video, or any combination thereof. The communication device can comprise any of wired and wireless telephones, online computer systems, cable systems, and other devices utilizing wired or wireless networks. The wired or wireless networks can comprise any of cellular networks, cable networks, telephone lines, Wi-Fi networks, Bluetooth networks and optical fiber networks. The Smart Sender System can schedule sending the message by taking at least one of the computer implemented steps of:
a) sending the message once immediately;
b) sending the message once at a first later time;
c) sending the message at a first series of recurring times starting immediately;
d) sending the message at a second series of recurring times starting at a second later time;
e) sending the message at a time when the service rate is lowest;
f) canceling sending the message;
g) providing the user with a first reminder at a third later time; and
h) providing the user with a second reminder at a third series of recurring times starting at a fourth later time,
   wherein step f) is not taken together with any other step, and at least one of the steps b), c), d), e), g) and h) is taken.

The user instruction specifying the one or more steps the communication device can take can be given to the communication device upon certain prompts, e.g. a display of one or more steps as options for the user to choose from, or in the absence of any prompts. The communication device can prompt the user, displaying one or more of these options, when the Smart Sender System is evoked. Alternatively, one or more of these steps can be taken by the Smart Sender System by default when it is evoked. The Smart Sender System can be evoked when the user gives any message-related instructions to the communication device, for example, when the user instructs the communication device to send, save or delete a message, when the user opens up a message for viewing, or when the user closes a message after viewing. Preferably, the Smart Sender System is evoked when the user instructs the communication device to send a message.

Sending a message immediately when a user instructs a communication device to send the message remains the only option in communication devices used in the industry and for sale in the market. If the user does not want to send the message immediately, the message can either be deleted upon user approval, or stored in the device as an unsent (draft) message until further instructions are given by the user later.

There are numerous reasons why a user of a communication device would like to send a message at a specific time later rather than immediately. Messages are not always generated at the same time that the user would like to have it delivered. This can happen due to strategic efficiency reasons relating to communications of a personal or professional manner. For example, the sender of the message is aware that the time the message is sent, if sent immediately, is inconvenient or impossible for the recipient to receive the message and/or to respond (e.g., the recipient may be asleep, in a meeting, on vacation, leave or day off). In these cases, the message can be scheduled to be sent at a later time, for example, when the sender believes that the recipient, based upon past experience, is likely to receive and respond to the message quickly. Other situations where pinpointing timed delivery of messages is desirable include, for example, sending a birthday, anniversary or season's greetings message on a specific day or even at a specific time of the day. Using the Smart Sender System, the user can cache birthday, anniversary and season's greetings messages for all family, business associates and friends to be delivered on a significant day at an exact time (such as exact time of birth).

At least two cost saving scenarios exist. A user may find it desirable to cache a message to be sent later based upon a more cost-efficient service rate (e.g., calling rate or data transmission rate) at a later time according to the service plan. When the user has already used up the remaining balance or is close to exhausting the remaining balance, he or she may want to cache a message until the balance has been increased to a sufficient amount or until a new billing cycle when the balance becomes full again according to the user's service plan. According to the present invention, information about the calling plan (e.g., the start and end time points of the “peak” and “off-peak” hours) and about the minimum balance remaining before caching a message is triggered (i.e., the “threshold balance”) can be set up by default or can be user specified at the time the user gives the instruction to send the message when the rate is lowest. Preferably, this information is set up by default, as it is not likely that the rate plan or the threshold balance settings change frequently. In this case, a message can be cached when the user instructs to send the message when the rate is lowest, and sent out later in an automated manner, in the absence of any other user instructions or interventions.

For those service plans in which different service rates apply at different times, a time when the rate is lowest for a given message is a period during which the service rate to send the given message is the lowest. The user can optionally set up a threshold balance during this period, either by default or at the time the instruction to send the message when the rate is lowest is given, wherein the message is sent during this period only if the remaining balance for the period is above the threshold. In this case, the time when the remaining balance for the period is above the threshold is considered to be the time when the rate is lowest. The threshold balance can be either zero or positive.

Alternatively, the user can set up a threshold balance, either by default or at the time the instruction to send a given message when the rate is lowest is given, irrespective of whether different rates apply at different times, wherein the given message is sent only if the remaining balance to send the given message is above the threshold. The threshold balance can be either zero or positive. In this case, the time when the remaining balance for sending the given message is above the threshold is considered to be the time when the rate is lowest. For example, a user may find it desirable to cache a message until the next billing cycle when the balance is full or until there is a sufficient increase in the remaining balance, when he or she finds that the remaining balance is too low and sending the message immediately may incur extra high service charges.

The user can instruct the device to cancel sending a message. This action can also be displayed by the Smart Sender System as a option to the user. Alternatively, canceling sending a message can be set up as default, so that no messages can be sent from the communication device. This is desirable when, for example, the user would like to stop all message sending indefinitely (e.g., when the user is traveling overseas for an indefinite period of time and want to avoid high service charges). Canceling sending a message can provide a convenient exit if the user does not want to give any other instructions or choose any other options provided by the system at the time and does not want to be reminded of the message again. When this instruction is given, or when this option is chosen, the message can either be deleted or be saved (e.g., as a draft for further revisions) based upon user instructions, and is not taken any action upon by the communication device until the user provides proper instructions at a time later, for example, to send the message, when the Smart Sender System can be evoked again and all of its options displayed for the user to choose from.

There are other situations when a user is not sure when to send a message out, or whether to send it out at all. According to the present invention, the user can instruct the communication device to provide a reminder at a system default or user-specified time later. Providing a reminder can also be displayed by the Smart Sender System as an option to the user by way of a prompt. Alternatively, providing a reminder can be set up as a default step when the Smart Sender System is evoked. This is desirable when, for example, the user would like to be reminded of all messages later, irrespective of whether the messages have been sent or not. The reminder can comprise prompts that can allow the user to specify one or more actions the communication device can take on a message to be sent. The one or more actions that the user can specify when prompted by the reminder can be any one or combination of:
action I, sending the message once immediately;
action II, sending the message once at a first later time;
action III, sending the message at a first series of recurring times starting immediately;
action IV, sending the message at a second series of recurring times starting at a second later time;
action V, sending the message at a time when the service rate is lowest;
action VI, canceling sending the message;
action VII, providing the user with a first reminder at a third later time; and
action VIII, providing the user with a second reminder at a third series of recurring times starting at a fourth later time,
   wherein action VI is not taken together with any other action.

The reminder can be in any form, either set up by default or specified by the user, either upon prompt or in the absence of any prompt, when instructing the communication device to provide the reminder. Non-limiting examples of forms of reminders include: any texts or images that the communication device can display, any sounds (e.g., ringer tones, a music, and voice prompts) that the communication device can play, any videos that the communication device can play, and any other features of the communication device that can draw the attention of the user (e.g., vibration of a cell phone).

Sending a message can be scheduled by default or by the user to happen once, or the same message can be scheduled by default or by the user to be sent at recurring times, starting either immediately or at a specific later time, with system default or user-specified intervals and/or number of recurring times. The intervals can be consistent (e.g., birthday or anniversary messages can be sent out on the same day each year), decremental or incremental. In the cases of consistent and incremental intervals, the same message can be sent by the system in an automated manner for an indefinite number of times in the absence of user intervention, unless there is a default or user-specified number of recurring times. In the case of decremental intervals, there is a maximal number of recurring times allowed and the message eventually ceases to be sent in the absence of user intervention when the remaining time is less than the next interval specified by default or by the user, unless there is a default or user-specified number of recurring times that is smaller than the maximal number of recurring times allowed.

Providing the user with a reminder can also be scheduled by default or by the user to happen once, or the same reminder can be scheduled by default or by the user to be provided at recurring times, starting at a specific later time, with system default or user-specified intervals and/or number of recurring times. The intervals can be consistent, decremental or incremental. In the cases of consistent and incremental intervals, the same reminder can be provided by the system for an indefinite number of times in the absence of user intervention, unless there is a default or user-specified number of recurring times. In the case of decremental intervals, there is a maximal number of recurring times allowed and the reminder eventually ceases to be provided in the absence of user intervention when the remaining time is less than the next interval specified by default or by the user, unless there is a default or user-specified number of recurring times that is smaller than the maximal number of recurring times allowed.

Each of steps a), b), c), d), e), f), g) and h) described above can be individually taken by the communication device. In addition, any combination of steps selected from steps a), b), c), d), e), g) and h) can be taken on a same message by the communication device. For example, the user would like to send the message immediately (step a)) and again at a specific later time (step b)) and to be reminded about the message at recurring times starting at another specific later time (step h)). By taking any of these steps individually or in combination with other steps, the Smart Sender System can allow maximal flexibility in scheduling message sending. Step fi (canceling sending), however, is not taken together with any other step. Once step f) is taken, the message is no longer monitored by the Smart Sender System until the system is evoked again by any instruction related to the message that can evoke the system.

According to another embodiment of the present invention, the Smart Sender System can allow recipient-specific rules. As used herein, a “recipient-specific rule” refers to any action a communication device can take on a message that is specific to a recipient of the message. A recipient-specific rule can be applied to a message to be sent by the Smart Sender System when the message contains a recipient (e.g., in its recipient list) with whom the recipient-specific rule is associated. A recipient-specific rule can comprise one or more actions the communication device can take on the message. The one or more actions can be any one or combination of actions I-VIII as described above, wherein action VI is not taken together with any other action. This is desirable when, for example, certain recipients would like to be contacted at only specific time points or during only specific time ranges of a day, or on only specific days of a year. Other recipients may not care that much and the message can be sent any time provided that the rate is lowest. Other examples of recipient-specific rules include inserting certain content (e.g., a signature) to a message sent to certain recipients. This is desirable, for example, when a user would like to add a business contact information to messages sent to business contacts and other casual, personalized signature to messages sent to certain family and friends automatically, without having to add such content repeatedly to messages sent to these recipients, or having to generate separate messages to these two types of recipients when the content of the message is otherwise the same. When a user evokes the Smart Sender System by giving any message-related instructions to a communication device, presumably he or she should have already specified at least one recipient to whom the message is intended to be sent to. (If not, the system can prompt the user to do so.) The recipient-specific rules can be set up by default, created for a recipient by the user when entering or editing the recipient's contact information (e.g., in a contact list), or they can be specified by the user when the Smart Sender System is evoked. Preferably, recipient-specific rules are created by the user when entering or editing a recipient's contact information and is stored in the communication device, associated with the recipient's contact information. Whenever the Smart Sender System is evoked, it can determine any recipient with a recipient-specific rule associated therewith. For each recipient with a recipient-specific rule associated therewith, the Smart Sender System can schedule sending the message by taking any of the computer implemented steps of: i) proceeding as specified by the recipient-specific rule associated with the recipient; ii) specifying a new recipient-specific rule for the recipient and proceeding as specified by the new recipient-specific rule; and iii) sending the message to the recipient with a recipient-specific rule associated therewith not applying any recipient-specific rule. For each recipient without a recipient-specific rule associated therewith, the Smart Sender System can schedule sending the message by taking any of the computer implemented steps of: i) creating a recipient-specific rule for the recipient without a recipient-specific rule associated therewith and proceeding as specified by the recipient-specific rule created; and ii) sending the message to the recipient without a recipient-specific rule associated therewith not applying any recipient-specific rule. Preferably, the message is sent to each recipient with a recipient-specific rule associated therewith as specified by the recipient-specific rule associated with the recipient, and sent to each recipient without a recipient-specific rule associated therewith not applying any recipient-specific rule, so that the message can be sent to each recipient with any evoked recipient-specific rule(s) applied automatically in the absence of any user instructions.

Recipient-specific rules can be evoked and applied in the absence of any user instruction or following user instructions, as described above. For each recipient to whom a message is sent not applying any recipient-specific rule, the system can take one or more actions the communication device can take on the message to be sent to the recipient, either by default or as instructed by the user, either upon prompt or in the absence of any prompt, said one or more actions being any one or combination of actions I-VIII as described previously, wherein action VI is not taken together with any other action. Alternatively, the message can be sent to such a recipient applying a content-specific rule (see below), either by default or as instructed by the user, either upon prompt or in the absence of any prompt. If the user does not instruct the communication device to take any action on the message sent to such recipients, and there is no default action to be taken, the message can be sent to these recipients immediately, which is equivalent to what happens when a message is sent in the absence of the Smart Sender System. For any recipient without a recipient-specific rule associated therewith and to whom the message is sent not applying any recipient-specific rule, the user can optionally create a recipient-specific rule for the recipient for future message sending, either upon prompt or in the absence of any prompt. The recipient-specific rule can be created and associated with the recipient's contact information (if it's already stored in the device) or saved with the recipient's contact information (if it's not yet stored in the device), to be evoked the next time a message is to be sent to the recipient. In this case, the newly created recipient-specific rule is not applied to the message being sent to the recipient at the moment, but can be applied to future messages to be sent to the recipient.

A recipient-specific rule can comprise any one of actions I-VIII. A recipient-specific rule can also comprise any combination of actions selected from actions I-V, VII and VIII. For example, the user would like to send all messages to a specific recipient immediately (action I) and again at a specific later time (action II) and to be reminded about all messages sent to the recipient at recurring times starting at another specific later time (action VIII). By including any of these actions individually or in combination with other actions in a recipient-specific rule, the Smart Sender System can allow maximal flexibility in scheduling message sending to specific recipients. Action VI (canceling sending), however, is not taken on a message together with any other action. Once action VI is taken, the message is no longer monitored by the Smart Sender System until the system is evoked again by any instruction related to the message that can evoke the system.

According to another embodiment of the present invention, the Smart Sender System can also allow content-specific rules. As used herein, a “content-specific rule” refers to any action a communication device can take on a message that is specific to the message or to certain content(s) the message contains. A content-specific rule can be evoked when a message to be sent contains certain content with which the content-specific rule is associated or when the message itself is associated with the content-specific rule. A content-specific rule can comprise one or more actions the communication device can take on a message to be sent. The one or more actions can be any one or combination of actions I-VIII as described above, wherein action VI is not taken on any message together with any other action. Other examples of content- specific rules include applying certain format (e.g. font and size) to certain content in a message. This is desirable, for example, when a user would like to emphasize certain texts in every message containing those texts, without having to repeatedly emphasizing the texts in each message containing such texts.

Content-specific rules are desirable when, for example, certain text messages containing certain characters in the subject line or the body can be sent out according to a specific rule, for example, a fire alarm warning message or a message for help during emergency needs to be sent out immediately, irrespective of the instant rate. Content-specific rules are also desirable when, for example, certain content of a message is large in size (e.g., in terms of megabytes) and takes a long time to transmit (e.g., a video message) and the user would like to delay sending of such message until when the rate is lowest. Therefore, content-specific rules are not limited to being evoked by what a certain content or what a certain message is, but can be evoked by any characteristic of a certain content or even of a whole message. Non-limiting examples of characteristics of a certain content include what the content is, the size (e.g., in terms of megabytes) of the content, and the time when the content is determined (e.g., generated, identified, or selected). Similarly, non-limiting examples of characteristics of a message include what content(s) the message contains, the size (e.g., in terms of megabytes) of the message, and the time when the message is determined (e.g., generated, identified or selected). For example, a content-specific rule can be evoked by the size of certain content being above a threshold. The type of content having such a threshold, and the threshold itself can each be determined either by default or as specified by the user. User specification can be given either upon prompt or in the absence of any prompt. A content-specific rule can be evoked by the time a certain message is determined being a specific time or within a specific time range. For example, it is desirable to postpone sending all messages generated during weekends until Monday, or to postpone sending all messages generated at night until regular business hours. The specific times and the specific time ranges that can evoke a content-specific rule can each be determined either by default or as specified by the user. User specification can be given either upon prompt or in the absence of any prompt.

A content-specific rule can be evoked by any single characteristic of a certain content or of a whole message. Alternatively, a content-specific rule can also be evoked by any combination of characteristics of a certain content and of a whole message. For example, a content-specific rule can be evoked by the size of a certain content (e.g., a video file) being over a threshold and the time the message is generated being within a specific time range (e.g., during weekends), so that only messages containing such content, the size of which being above the threshold, and generated during the specific time range, evoke the content-specific rule. The single characteristics of a certain content or of a whole message, the combinations of characteristics of a certain content and a whole message, the certain content itself (i.e., what the content is), and the whole message itself (i.e., what content(s) the message contains), each of which can evoke a content-specific rule, can be determined either by default or as specified by the user. User specification can be given either upon prompt or in the absence of any prompt.

When a user evokes the Smart Sender System by giving any message-related instructions to a communication device, presumably he or she should have already entered the content of the message. (If not, the system can prompt the user to do so.) The content-specific rules can be set up by default, created and stored in the communication device, or they can be specified by the user when the Smart Sender System is evoked. Preferably, the content-specific rules are set up by default or created and stored in the communication device. Whenever the Smart Sender System is evoked, it can determine any existing content-specific rule(s) that can be evoked and schedule sending the message to each recipient in the recipient list of the message by taking any of the computer implemented steps of: i) proceeding as specified by one of the content-specific rule(s) that can be evoked, if there is any; ii) creating a new content-specific rule irrespective of whether any existing content-specific rules can be evoked, and proceeding as specified by the new content-specific rule; and iii) sending the message to the recipient not applying any content-specific rule. If the system finds that there is no applicable content-specific rule for the message, the system can optionally ask the user if any content-specific rule based on the content of the message should be created before sending the message. Alternatively, if the user decides to apply a new content-specific rule to the message, he or she can create a new one based on the content of the message, either upon prompt or in the absence of any prompt, irrespective of whether any existing content-specific rules can be evoked. If the user creates one content-specific rule for the message based on the content of the message, the message can then be sent to each recipient as specified by the newly created rule. If more than one content-specific rules are created by the user based on the content of the message, the user can choose one from them for each recipient and send the message according to the chosen rule, either upon prompt or in the absence of any prompt. Any newly created content-specific rule that is not applied to the message being sent can be saved in the communication device so that it can be evoked the next time a message containing such content is to be sent. Preferably, only one existing content-specific rule can be evoked for a given message, and only one new content-specific rule can be created by the user for a given message. However, it is possible that more than one content-specific rules can be evoked and/or created for the same message. For example, a message for help in an emergency can have a video clip of the emergency, and both the text “HELP!” and the video clip have a content-specific rule, respectively. If more than one content-specific rules are evoked and/or created, the system can apply, for each recipient, by default or as instructed by the user, either upon prompt or in the absence of any prompt, one content-specific rule among all the rules evoked and/or created. Preferably, different content-specific rules can have different priorities, set up by default and stored in the communication device. In this case, if more than one content-specific rules can be evoked, unless instructed by the user otherwise, the system can automatically apply the content-specific rule that can be evoked with the highest priority among all the content-specific rules that can be evoked, and send the message to all recipients as specified by the content-specific rule with the highest priority, in the absence of any user intervention.

Content-specific rules can be evoked and applied in the absence of any user instruction or created and specified following user instructions, as described above. For each recipient to whom a message is sent not applying any content-specific rule, the system can take one or more actions the communication device can take on the message to be sent to the recipient, either by default or as instructed by the user, either upon prompt or in the absence of any prompt, said one or more actions being any one or combination of actions I-VIII as described previously, wherein action VI is not taken together with any other action. Alternatively, the message can be sent to such a recipient applying a recipient-specific rule associated with the recipient, either by default or as instructed by the user, either upon prompt or in the absence of any prompt. If the user does not instruct the communication to take any action on the message sent to such recipients, and there is no default action to be taken, the message can be sent to these recipients immediately, which is equivalent to what happens when a message is sent in the absence of the Smart Sender System.

A content-specific rule can comprise any one of actions I-VIII. A content-specific rule can also comprise any combination of actions selected from actions I-V, VII and VIII. For example, the user would like to send all messages containing a certain content immediately (action I) and again at a specific later time (action II) and to be reminded about all messages containing the content at recurring times starting at another specific later time (action VIII). By including any of these actions individually or in combination with other actions in a content-specific rule, the Smart Sender System can allow maximal flexibility in scheduling sending messages containing specific contents. Action VI (canceling sending), however, is not taken on a message together with any other action. Once action VI is taken, the message is no longer monitored by the Smart Sender System until the system is evoked again by any instruction related to the message that can evoke the system.

When both recipient-specific rules and content-specific rules exist in the same system and are applicable to a same message, i.e., when a message contains in its recipient list one or more recipients with a recipient-specific rule associated therewith and certain contents that can evoke an existing content-specific rule, the system can determine either by default or following user instructions upon prompt or in the absence of any prompt which set of rules (i.e., recipient-specific rules or content-specific rules) has higher priority, determine any applicable rules that belong to the set of rules having higher priority, and follow the procedures described above for the set of rules having higher priority. For each of those recipients to whom the user decides to send the message not applying any rule that belongs to the set of rules having higher priority, the system can decide either by default or following user instructions upon prompt or in the absence of any prompt whether to send the message to the recipient applying a rule that belongs to the set of rules having lower priority. For each of those recipients to whom the user decides to send the message not applying any recipient- or content-specific rules, the system can, either by default or following user instructions upon prompt or in the absence of any prompt, take one or more actions the communication device can take on the message to be sent to the recipient, said one or more actions being any one or combination of actions I-VIII as described previously, wherein action VI is not taken on any message together with any other action. If the user does not instruct the communication device to take any action on the message sent to such recipients, and there is no default action to be taken, the message can be sent to these recipients immediately, which is equivalent to what happens when a message is sent in the absence of the Smart Sender System.

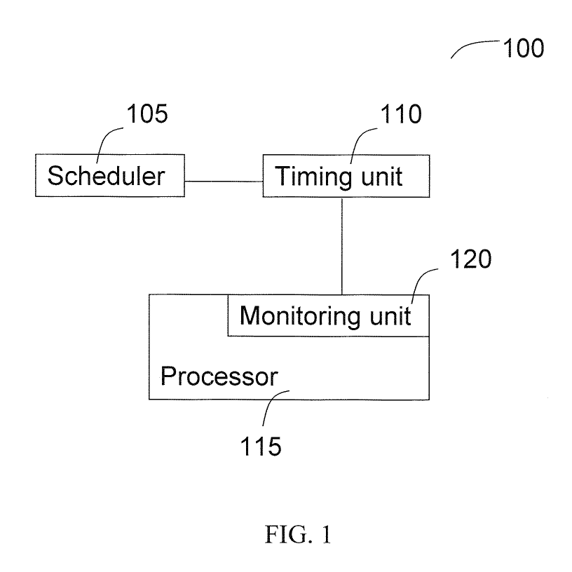

Referring to FIG. 1, an exemplary Smart Sender System 100 of the type to which the present invention may be applied includes a scheduler 105 configured to determine one or more times when one or more actions are to be taken on a give message, a timing unit 110 configured to generate and transmit, at the one or more times determined by the scheduler, one or more instructions to take the one or more actions, and a processor 115, having a monitoring unit 120, the processor 105 configured to take the one or more actions on the given message in response to the monitoring unit 120 receiving the one or more instructions and in accordance with the one or more instructions received.

In alternative embodiments of the present invention, either scheduler 105, or timing unit 110, or both, may be part of processor 115. Timing unit 110 may also be part of scheduler 105. The one or more actions can be any one or combination of: action I, send the message once immediately; action II, send the message once at a first later time; action III, send the message at a first series of recurring times starting immediately; action IV, send the message at a second series of recurring times starting at a second later time; action V, send the message at a time when the rate is lowest; action VI, cancel the sending of the message; action VII, provide to the user a first reminder at a third later time; and action VIII, provide to the user a second reminder at a third series of recurring times starting at a fourth later time, wherein action VI is not taken on the given message if any other action is taken.

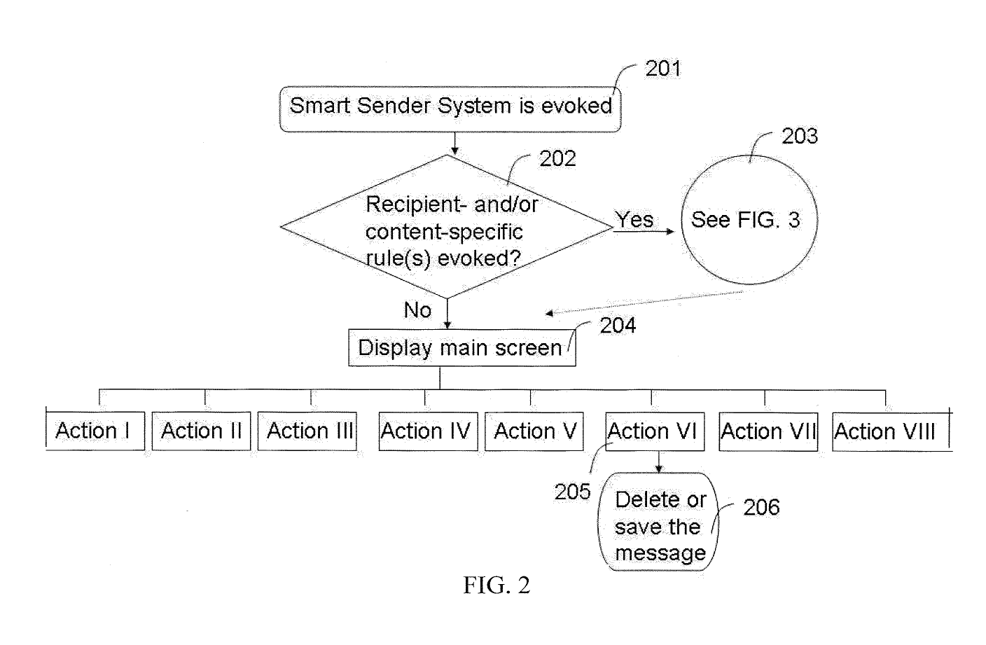

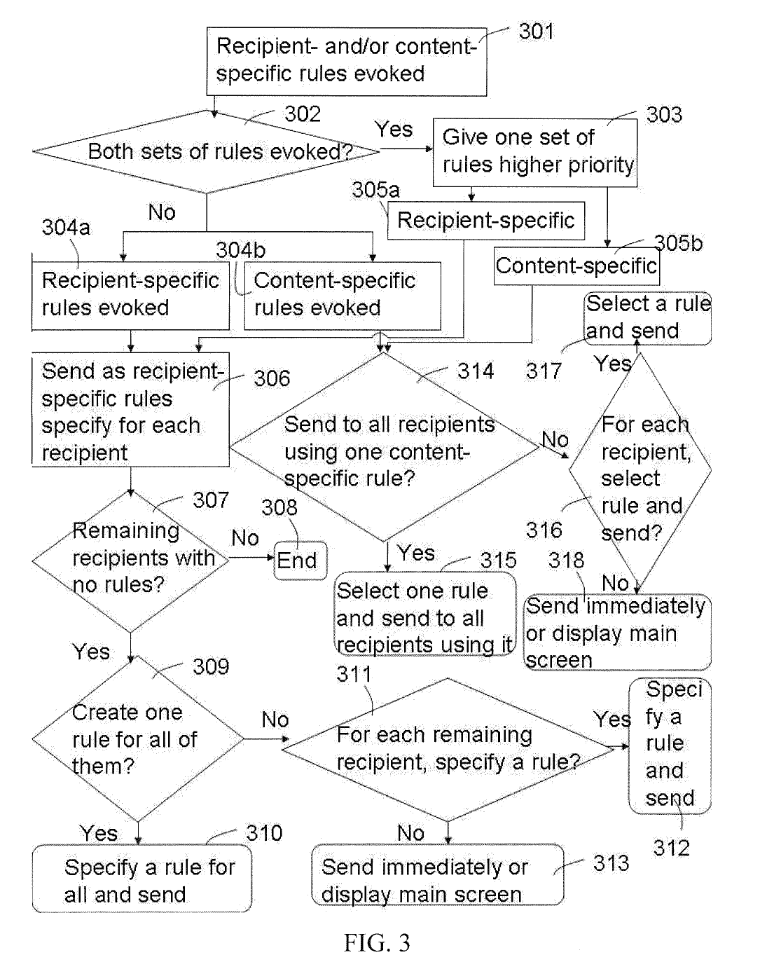

The flowchart of FIG. 2 illustrates an example of the basic processing of the Smart Sender System according to one embodiment of the present invention. When the Smart Sender System is evoked for a message (step 201), the system can first determine if the message can evoke any existing recipient- and/or content-specific rules (step 202). If so, the recipient- and/or content-specific rules evoked can be applied (step 203; see FIG. 3). If not, then the system can display a main screen with one or more actions the communication device can take on the message as options for the user to choose from (step 204). Optionally, before displaying the main screen with the one or more actions, the system can ask the user to specify recipient-specific rules for each recipient in the recipient list without a recipient-specific rule and/or to specify content-specific rule for the message if there is no applicable content-specific rule to the message (not shown).

The one or more actions displayed in the main screen as options to the user can include one or more actions selected from actions I-VIII as described above. The user can choose one or more of these actions to be taken on the message, provided that action VI is not taken together with any other action and at least one of the actions II-V, VII and VIII is taken.

If the user chooses to cancel sending the message (i.e., taking action VI; step 205), the system can ask the user if he or she would like to delete or save the message and proceed as the user specifies (step 206). Messages deleted in this way can be either permanently deleted or transferred to a recycle bin wherein the user can permanently delete the message in the recycle bin or move the message out of the recycle bin at a later time. Messages saved in this way are no longer monitored by the Smart Sender System until the Smart Sender System is evoked for the message again (step 201).

The reminder that can be provided when actions VII or VIII or both are taken can be displayed in the form of the main screen at step 204 with one or more of the actions I-VIII as options. Alternatively, the reminder can be in any form, either set by default or specified by the user upon prompt or in the absence of any when he or she choose to be reminded (not shown). Examples of different forms of reminders have been given above.

The flowchart in FIG. 3 illustrates an example of the processing of the Smart Sender System according to another embodiment of the present invention, when at least one recipient-specific rule or at least one content-specific rule or both are evoked for a message (step 301). The system can first determine if both sets of rules are evoked (step 302). If recipient-specific rules and content-specific rules both exist in the same system, and are found to be both evoked, the system can determine which one set of these rules has higher priority, either by default or as instructed by the user, either upon prompt or in the absence of any prompt (step 303). If only one set of rules is evoked, or after one set of rules is given higher priority, either by default or as instructed by the user upon prompt or in the absence of any prompt (step 303), the evoked (304a or 304b) or higher priority (305a or 305b) set of rules is applied.

When recipient-specific rules are applied, and there are more than one recipient in the recipient list, the message can be sent to each recipient with a recipient-specific rule as specified by the rule (step 306). The system can then determine if there are remaining recipients in the recipient list with no recipient-specific rules (step 307). If no such recipients remain in the list, scheduling of message sending is completed (step 308). If there are recipients remaining in the recipient list without a recipient-specific rule, the system can prompt the user to decide if he or she would like to create one recipient-specific rule for all remaining recipients in the list without a recipient-specific rule (step 309). If the user chooses yes, he or she can create the rule when prompted or in the absence of any prompt, to apply to the message sent to all remaining recipients (step 310). Alternatively, the user can decide for each remaining recipient without a recipient-specific rule whether he or she would like to create a recipient-specific rule for that recipient (step 311) and send the message to that recipient as specified by the recipient-specific rule created (step 312). For those recipients for whom the user does not create a recipient-specific rule, the message can be sent immediately or the main screen can be displayed (step 313). Alternatively, for those recipients for whom there is no recipient-specific rule associated therewith and the user does not create a recipient- specific rule, the message can be sent as specified by a content-specific rule, if there is any applicable (not shown).

When content-specific rules are applied, and there are more than one content-specific rules applicable to the message, the system can determine, either by default or as instructed by the user upon prompt or in the absence of any prompt, whether to send the message to all recipients using one applicable content-specific rule (step 314). To determine which content-specific rule is applied by default, a list of all existing content-specific rules can be stored in the communication device's memory and different priority can be assigned to each content-specific rule in the list. Assignment of priority to each content-specific rule in the list can be done by the device manufacturer, by the service provider, or by the user at the first time the Smart Sender System is set up by the user. The list can be editable by the user at any time, for example, to add or delete certain content-specific rules and to change the order of priority of certain content-specific rules. When the user is prompted to select one content-specific rule to apply to the message sent to all recipients (step 315), the default is preferably the one with the highest priority among all applicable content-specific rules according to the list, even though the user can select any one of the applicable content-specific rules when prompted. If the user decides not to apply a single content-specific rule to send the message to all recipients, the user can select one applicable content-specific rule for each recipient (step 316) and send the message to that recipient according to the content-specific rule selected (step 317). Application of a content-specific rule for a given recipient completes the scheduling of message sending to the given recipient. For those recipients for whom the user does not select a content-specific rule, the message can be sent immediately or the main screen can be displayed (step 318). The user can create a new content-specific rule based on the content of the message and instruct the system to apply the newly created content-specific rule to the message sent to all recipients or to one or more specific recipients (not shown). For those recipients for whom the user does not select or create any content-specific rule, the message can be sent to the recipients as specified by any applicable recipient-specific rule(s) (not shown).

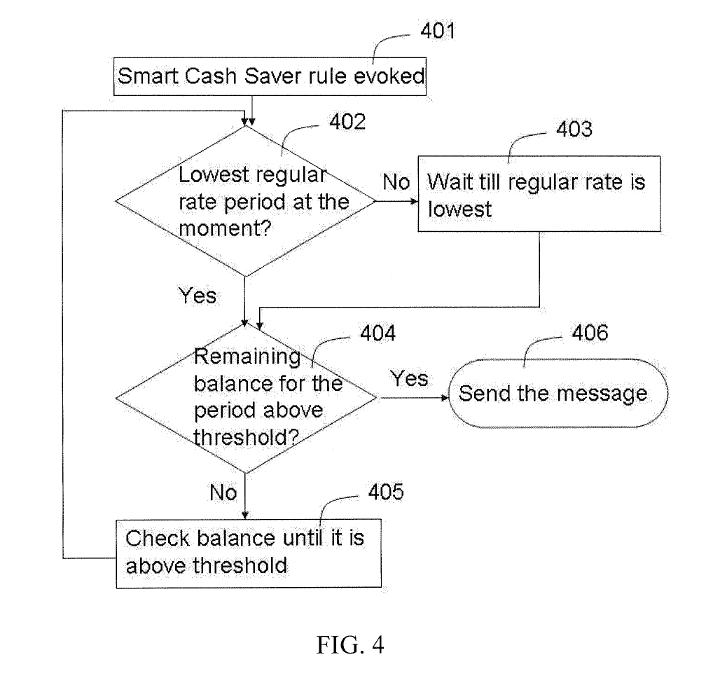

The flowchart in FIG. 4 illustrates an example of the processing of the Smart Sender System according to yet another embodiment of the present invention, when action V is taken on a message (taking action V is also referred to herein as “evoking the ‘Smart Cash Saver’ rule”; step 401). The system can first determine if the time the Smart Cash Saver rule is evoked is during the period when the regular service rate (e.g., calling rate or data transmission rate) is lowest (step 402). In order to do this, the system can compare the clock of the communication device, which can be synchronized (e.g., with a time server) and adjusted for different time zones, with a timetable either set up by the manufacturer or the service provider or specified by the user when the Smart Cash Saver rule is evoked that contains service rate information in relation to time. (Methods for synchronizing and adjusting the clock of communication devices are well known to those skilled in the art.) For example, certain cell phone carriers have service plans that designate the time period between 9:00 pm and 7:00 am as the “unlimited” calling period (or “off-peak” hours), during which phone calls received and made to certain destinations are free. The timetable can be stored in the communication device's memory or can be stored externally and accessible by the communication device automatically. For example, the timetable can be stored in a remote server and accessible by the communication device by methods known to those skilled in the art. By looking up the timetable, the system can determine if the time the Smart Cash Saver rule is evoked falls within the time period when the regular service rate is lowest. Optionally, after looking up the timetable, the system can notify the user whether the time the Smart Cash Saver rule is evoked falls within the time period when the regular service rate is lowest, and wait for the user's instruction whether to proceed with message sending (not shown). If the time the Smart Cash Saver rule is evoked does not fall within the time period when the regular service rate is lowest, or upon user instruction, by referring to the timetable and keeping the clock of the communication device updated (synchronized and adjusted for time zone difference), the system can wait until the time when the regular rate is lowest according to the timetable before sending the message (step 403).

In addition to checking when the service rate is lowest, the system can further check if the remaining balance at the time the Smart Cash Saver rule is evoked is above a certain threshold (step 404). The remaining balance the system can check include any form of balance, for example, remaining cash balance in the user account, remaining minutes of service (e.g., calling or data transmission) in the service plan at the instant service rate, and remaining data transmission volume allowed (e.g., in the form of megabytes) in the service plan at the instant service rate, before a higher rate or additional charges would apply, if the message is to be sent immediately. Methods for checking various forms of balance remaining using a communication device are well known to those skilled in the art. The threshold balance can be set up by default or specified by the users, either upon prompt or in the absence of any prompt, when the Smart Cash Saver rule is evoked. Alternatively, the system can check and display one or more forms of balance to the user when the Smart Cash Saver rule is evoked, and wait for the user's instruction whether to send the message immediately or wait until the balance becomes above the threshold (not shown).

If the balance is found to be below a certain threshold set up by default or specified by the user, either upon prompt or in the absence of any prompt, when the Smart Cash Saver rule is evoked, or upon user instruction, the system can check at a time set up by default or specified by the user upon prompt or in the absence of any prompt if the balance becomes above the threshold (step 405). This time, either set up by default or specified by the user upon prompt or in the absence of any prompt, can be recurring times. In the situations where the time a balance increase is regular or predictable (e.g., the balance becomes full with the start of a new billing cycle, or the user pay for the service regularly), the system can check the balance again at a time set up by default or ask the user to specify a time to check again. In the situation where it is not known when the next balance increase is going to be, or upon checking at the time set up by default or specified by the user, the system finds that the balance is still below the threshold, the system can automatically check the balance at recurring times set up by default or specified by the user until the balance is above the threshold. When the balance is found to be above the threshold, the system can start checking again if the instant service rate is lowest (step 402).

When the system has determined a time when the rate is lowest and/or the remaining balance is above a threshold, the message can be sent in an automated manner (step 406).

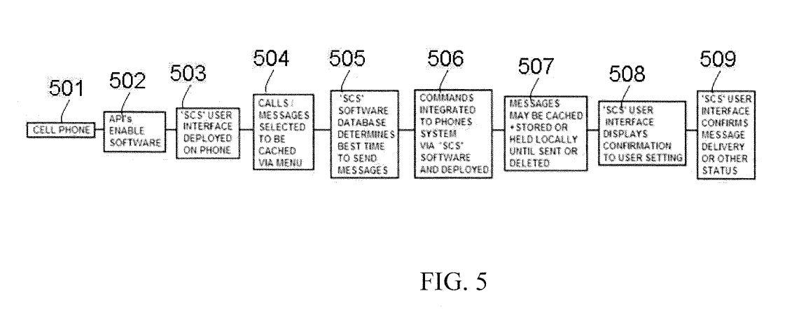

The user-interface of the Smart Sender System can be installed on a communication device by programming the interface into the device. The system can work in the same way that any application that requires access into multiple phases of a communication device would work. For example, the system software can jibe with its host clock to maintain time zone continuity via integration with the device's application programming interfaces (API's) and hardware and software systems such as the memory, inbox and outbox, the stored box and the contact list. FIG. 5 illustrates an example of the deployment and execution process of the Smart Cash Saver (also referred to herein as “SCS”) software in a cell phone 501. After enablement of the software by the API's (step 502), “SCS” user interface is deployed on the phone (step 503). Calls or other messages can be selected to be cached via a menu (step 504), and the “SCS” database can determine the best time to send the messages (step 505), e.g., the “SCS” database can contain the timetable described in FIG. 4. Certain commands can be integrated into the phone's system via “SCS” software and deployed (step 506). Messages can be cached until they are sent or deleted (step 507). The “SCS” user interface can display confirmation to any user settings (step 508), and can also confirm message delivery or other status of the message by providing notification to the user (step 509). Methods of programming and deployment of the interface of software applications in communication devices are well known to those skilled in the art.

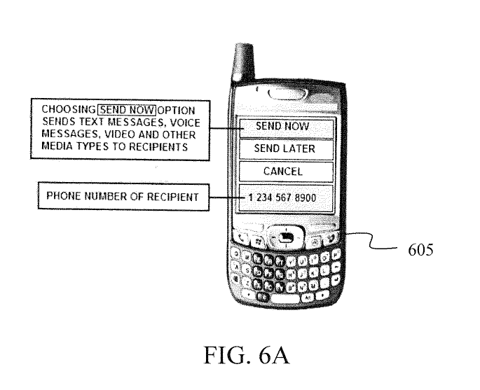

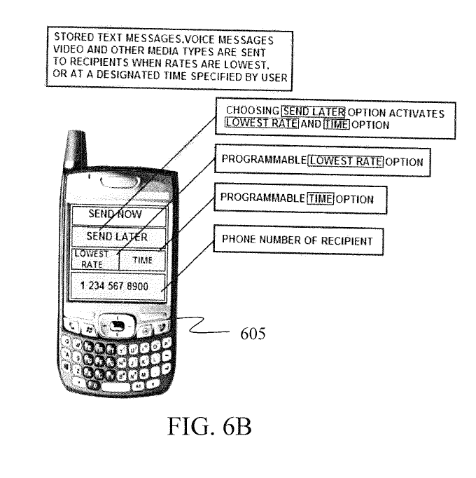

FIGS. 6A-B and 7A-B illustrate examples of displays on the screen of a cell phone 605 and of a PDA 705, respectively, according to different embodiments of the present invention, when a user completes generation of a message and press “SEND.” The system can work not only with cell phones and other wireless communication devices, but also with landline phone and online computer systems. For example, the system can function as a third party server system or web application that functions remotely and caches and directs message sending as a service. In this case, the messages can be cached in a facility that is not the service provider's main network operations center (NOC), but a strategic NOC made for the storage and deployment of user messages.

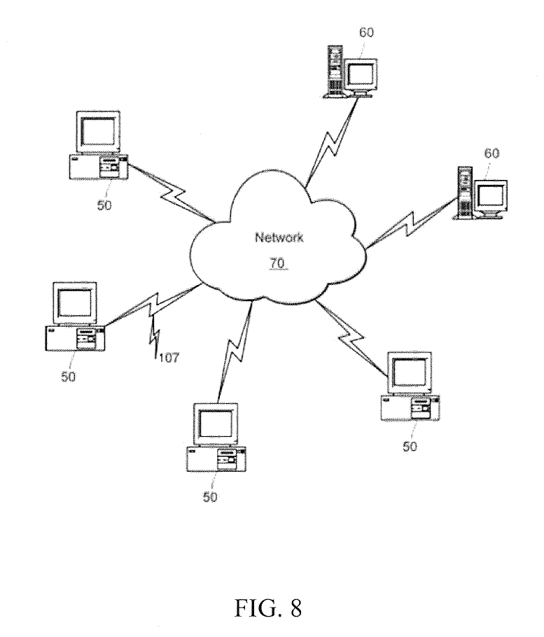

FIG. 8 illustrates a computer network or similar digital processing environment in which the present invention may be implemented.

Client computer(s)/devices 50 and server computer(s) 60 provide processing, storage, and input/output devices executing application programs and the like. Client computer(s)/devices 50 can also be linked through communications network 70 to other computing devices, including other client devices/processes 50 and server computer(s) 60. The server computers 60 can be the third party server system or the service provider's main NOC, as described above. Communications network 70 can be part of a remote access network, a global network (e.g., the Internet), a worldwide collection of computers, Local area or Wide area networks, and gateways that currently use respective protocols (TCP/IP, Bluetooth, Wi-Fi etc.) to communicate with one another. Other electronic device/computer network architectures are suitable.

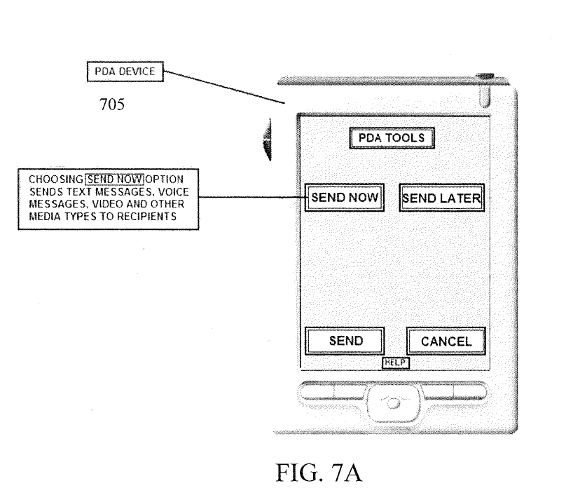

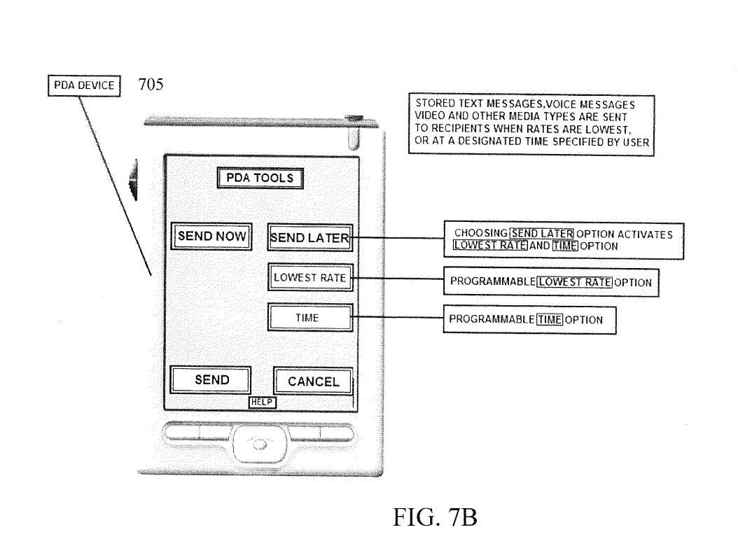

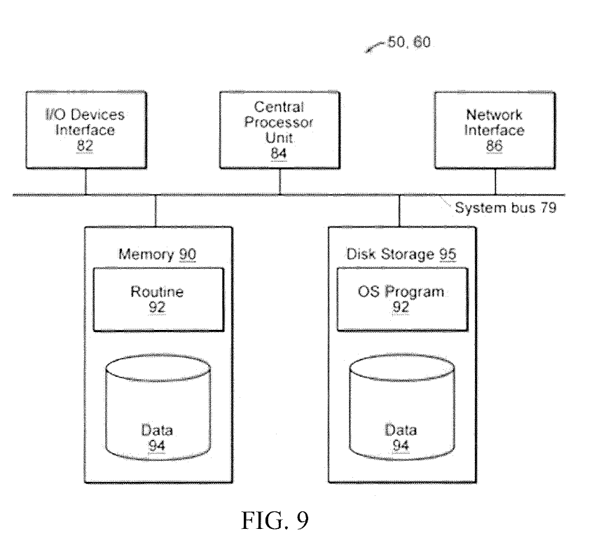

FIG. 9 is a diagram of the internal structure of a computer (e.g., client processor/device 50 or server computers 60) in the computer system of FIG. 8. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, volatile memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 7). Volatile memory 90 provides volatile storage for computer software instructions 92 and data 94 used to implement an embodiment of the present invention (e.g., the Smart Sender System detailed above). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 (see FIG. 8) embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

The present invention may be implemented in a variety of communication device architectures. The computer network of FIGS. 8 and 9 are for purposes of illustration and not limitation of the present invention.

While this invention has been particularly shown and described with references to example embodiments thereof, it will be understood by those skilled in the art that various changes in form and details may be made therein without departing from the scope of the invention encompassed by the appended claims.

What is claimed is:

1. A computer implemented method for transferring sender-to-recipient data in a multicomputer environment in response to priority characteristics of the data, said method comprising the computer implemented steps of:
determining a message to be sent using a communication device; and
scheduling sending the message using the communication device, comprising at least one of the computer implemented steps of:
a) sending the message once immediately;
b) sending the message once at a first later time;
c) sending the message at a first series of recurring times starting immediately;
d) sending the message at a second series of recurring times starting at a second later time;
e) sending the message at a time when the service rate is lowest;
f) canceling sending the message;
g) providing the user with a first reminder at a third later time; and
h) providing the user with a second reminder at a third series of recurring times starting at a fourth later time,
wherein step f) is not taken together with any other step, and at least one of the steps b), c), d), e), g) and h) is taken.

2. The method of claim 1, wherein the message comprises audio information, or visual information, or a combination thereof, the audio information comprising any audible sound, including voice, and the visual information comprising any text, still image or video, or any combination thereof.

3. The method of claim 1, wherein the communication device comprises any of wired and wireless telephones, online computer systems, cable systems, and other devices utilizing wired or wireless networks, the wired or wireless networks comprising any of cellular networks, cable networks, telephone lines, Wi-Fi networks, Bluetooth networks and optical fiber networks.

4. The method of claim 1, further comprising at least one of the computer implemented steps of:
determining at least one of the first later time, the second later time, the third later time and the fourth later time;
determining the number of recurring times in at least one of the first series of recurring times, the second series of recurring times and the third series of recurring times;
determining the intervals between the recurring times in at least one of the first series of recurring times, the second series of recurring times and the third series of recurring times, the intervals being any of consistent intervals, incremental intervals and decremental intervals; and
determining at least one of the first reminder and the second reminder, wherein at least one of the first reminder and the second reminder comprises prompts that can allow the user to specify one or more actions the communication device can take on the message, said one or more actions that the user can specify when prompted by at least one of the first reminder and the second reminder being any one or combination of:
action I, sending the message once immediately;
action II, sending the message once at a fifth later time;
action III, sending the message at a fourth series of recurring times starting immediately;
action IV, sending the message at a fifth series of recurring times starting at a sixth later time;
action V, sending the message at a second time when the service rate is lowest;
action VI, canceling sending the message;
action VII, providing the user with a third reminder at a seventh later time; and
action VIII, providing the user with a fourth reminder at a sixth series of recurring times starting at an eighth later time,
wherein action VI is not taken together with any other action.

5. The method of claim 1, further comprising the computer implemented step of determining the time when the service rate is lowest, wherein the time when the service rate is lowest for the message is a period during which the regular service rate to send the message is the lowest, if there are more than one period, each with a different regular service rate, according to a service plan.

6. The method of claim 5, further comprising the computer implemented step of determining a remaining balance for the period during which the regular service rate to send the message is the lowest, wherein the message is sent when the remaining balance is above a threshold, the threshold being determined either by default or as specified by the user, wherein user specification is given either upon prompt or in the absence of any prompt.

7. The method of claim 1, further comprising the computer implemented step of determining the time when the service rate is lowest, wherein the time when the service rate is lowest for the message is a time when a remaining balance for sending the message is above a threshold, irrespective of whether the time when the remaining balance for sending the message is above the threshold is during a period during which the regular service rate to send the message is the lowest, if there are more than one period, each with a different regular service rate, according to a service plan, the threshold being determined either by default or as specified by the user, wherein user specification is given either upon prompt or in the absence of any prompt.

8. A computer implemented method for transferring sender-to-recipient data in a multicomputer environment in response to priority characteristics of the data, said method comprising the computer implemented steps of:
a) determining a message to be sent to one or more recipients using a communication device;
b) for the message, determining any recipient with a recipient-specific rule associated therewith;
c) scheduling sending the message to each recipient with a recipient- specific rule associated therewith using the communication device, comprising any of the computer implemented steps of:
i) proceeding as specified by the recipient-specific rule associated with the recipient;
ii) specifying a new recipient-specific rule for the recipient and proceeding as specified by the new recipient-specific rule; and
iii) sending the message to the recipient with a recipient-specific rule associated therewith not applying any recipient-specific rule; and
d) scheduling sending the message to each recipient without a recipient-specific rule associated therewith using the communication device, comprising any of the computer implemented steps of:
i) creating a recipient-specific rule for the recipient without a recipient-specific rule associated therewith and proceeding as specified by the recipient-specific rule created; and
ii) sending the message to the recipient without a recipient-specific rule associated therewith not applying any recipient-specific rule.

9. The method of claim 8, further comprising the computer implemented step of storing one or more recipient-specific rules in the communication device.

10. The method of claim 8, wherein at least one recipient-specific rule comprises one or more actions the communication device can take on the message, said one or more actions being any one or combination of:
action I, sending the message once immediately;
action II, sending the message once at a first later time;
action III, sending the message at a first series of recurring times starting immediately;
action IV, sending the message at a second series of recurring times starting at a second later time;
action V, sending the message at a time when the service rate is lowest;
action VI, canceling sending the message;
action VII, providing the user with a first reminder at a third later time; and
action VIII, providing the user with a second reminder at a third series of recurring times starting at a fourth later time,
wherein action VI is not taken together with any other action.

11. The method of claim 10, further comprising at least one of the computer implemented steps of:
determining at least one of the first later time, the second later time, the third later time and the fourth later time;
determining the number of recurring times in at least one of the first series of recurring times, the second series of recurring times and the third series of recurring times;
determining the intervals between the recurring times in at least one of the first series of recurring times, the second series of recurring times and the third series of recurring times, the intervals being any of consistent intervals, incremental intervals and decremental intervals; and
determining at least one of the first reminder and the second reminder, wherein at least one of the first reminder and the second reminder comprises prompts that can allow the user to specify one or more actions the communication device can take on the message, said one or more actions that the user can specify when prompted by at least one of the first reminder and the second reminder being any one or combination of:
action IX, sending the message once immediately;
action X, sending the message once at a fifth later time;
action XI, sending the message at a fourth series of recurring times starting immediately;
action XII, sending the message at a fifth series of recurring times starting at a sixth later time;
action XIII, sending the message at a second time when the service rate is lowest;
action XIV, canceling sending the message;
action XV, providing the user with a third reminder at a seventh later time; and
action XVI, providing the user with a fourth reminder at a sixth series of recurring times starting at an eighth later time,
wherein action XIV is not taken together with any other action.

12. The method of claim 10, further comprising the computer implemented step of determining the time when the service rate is lowest, wherein the time when the service rate is lowest for the message is a period during which the regular service rate to send the message is the lowest, if there are more than one period, each with a different regular service rate, according to a service plan.

13. The method of claim 12, further comprising the computer implemented step of determining a remaining balance for the period during which the regular service rate to send the message is the lowest, wherein the message is sent when the remaining balance is above a threshold, the threshold being determined either by default or as specified by the user, wherein user specification is given either upon prompt or in the absence of any prompt.

14. The method of claim 10, further comprising the computer implemented step of determining the time when the service rate is lowest, wherein the time when the service rate is lowest for the message is a time when a remaining balance for sending the message is above a threshold, irrespective of whether the time when the remaining balance for sending the message is above the threshold is during a period during which the regular service rate to send the message is the lowest, if there are more than one period, each with a different regular service rate, according to a service plan, the threshold being determined either by default or as specified by the user, wherein user specification is given either upon prompt or in the absence of any prompt.

15. The method of claim 8, wherein sending the message to the recipient with or without a recipient-specific rule associated therewith not applying any recipient-specific rule comprises sending the message to the recipient with or without a recipient-specific rule associated therewith applying a content-specific rule.

16. A computer implemented method for transferring sender-to-recipient data in a multicomputer environment in response to priority characteristics of the data, said method comprising the computer implemented steps of:
a) determining a message to be sent to one or more recipients using a communication device;
b) for the message, determining any existing content-specific rule(s) that can be evoked; and
c) scheduling sending the message to each recipient of the message using the communication device, comprising any of the computer implemented steps of:
i) proceeding as specified by one of the content-specific rule(s) that can be evoked, if there is any;
ii) creating a new content-specific rule irrespective of whether any existing content-specific rule(s) can be evoked, and proceeding as specified by the new content-specific rule; and
iii) sending the message to the recipient not applying any content- specific rule, irrespective of whether any existing content-specific rule(s) can be evoked.

17. The method of claim 16, further comprising the computer implemented step of storing one or more content-specific rules in the communication device.

18. The method of claim 16, wherein at least one content-specific rule comprises one or more actions the communication device can take on the message, said one or more actions being any one or combination of:
action I, sending the message once immediately;
action II, sending the message once at a first later time;
action III, sending the message at a first series of recurring times starting immediately;
action IV, sending the message at a second series of recurring times starting at a second later time;
action V, sending the message at a time when the rate is lowest;
action VI, canceling sending the message;
action VII, providing the user with a first reminder at a third later time; and
action VIII, providing the user with a second reminder at a third series of recurring times starting at a fourth later time,
wherein action VI is not taken together with any other action.

19. The method of claim 18, further comprising at least one of the computer implemented steps of:
determining at least one of the first later time, the second later time, the third later time and the fourth later time;
determining the number of recurring times in at least one of the first series of recurring times, the second series of recurring times and the third series of recurring times;
determining the intervals between the recurring times in at least one of the first series of recurring times, the second series of recurring times and the third series of recurring times, the intervals being any of consistent intervals, incremental intervals and decremental intervals; and
determining at least one of the first reminder and the second reminder, wherein at least one of the first reminder and the second reminder comprises prompts that can allow the user to specify one or more actions the communication device can take on the message, said one or more actions that the user can specify when prompted by at least one of the first reminder and the second reminder being any one or combination of:
action IX, sending the message once immediately;
action X, sending the message once at a fifth later time;
action XI, sending the message at a fourth series of recurring times starting immediately;
action XII, sending the message at a fifth series of recurring times starting at a sixth later time;
action XIII, sending the message at a second time when the service rate is lowest;
action XIV, canceling sending the message;
action XV, providing the user with a third reminder at a seventh later time; and
action XVI, providing the user with a fourth reminder at a sixth series of recurring times starting at an eighth later time,
wherein action XIV is not taken together with any other action.

20. The method of claim 18, further comprising the computer implemented step of determining the time when the service rate is lowest, wherein the time when the service rate is lowest for the message is a period during which the regular service rate to send the message is the lowest, if there are more than one period, each with a different regular service rate, according to a service plan.

21. The method of claim 20, further comprising the computer implemented step of determining a remaining balance for the period during which the regular service rate to send the message is the lowest, wherein the message is sent when the remaining balance is above a threshold, the threshold being determined either by default or as specified by the user, wherein user specification is given either upon prompt or in the absence of any prompt.

22. The method of claim 18, further comprising the computer implemented step of determining the time when the service rate is lowest, wherein the time when the service rate is lowest for the message is a time when a remaining balance for sending the message is above a threshold, irrespective of whether the time when the remaining balance for sending the message is above the threshold is during a period during which the regular service rate to send the message is the lowest, if there are more than one period, each with a different regular service rate, according to a service plan, the threshold being determined either by default or as specified by the user, wherein user specification is given either upon prompt or in the absence of any prompt.

23. The method of claim 16, wherein sending the message to the recipient not applying any content-specific rule comprises sending the message to the recipient applying a recipient-specific rule.

24. A computer program product comprising a computer usable medium having a computer readable program for scheduling sending of sender-to-recipient messages using a communication device, wherein for a given message to be sent using the communication device, the computer readable program when executed by a computer causes the computer to take one or more of the following steps:
a) send the given message once immediately;
b) send the given message once at a first later time;
c) send the given message at a first series of recurring times starting immediately;
d) send the given message at a second series of recurring times starting at a second later time;
e) send the given message at a time when the service rate is lowest;
f) cancel sending the given message;
g) provide the user with a first reminder at a third later time; and
h) provide the user with a second reminder at a third series of recurring times starting at a fourth later time,
wherein step t) is not taken together with any other step, and at least one of the steps b), c), d), e), g) and h) is taken.

25. A system to transfer sender-to-recipient data in a multicomputer environment in response to priority characteristics of the data, the system comprising:
a scheduler configured to determine one or more times when one or more actions are to be taken on a given message;
a timing unit configured to generate and transmit, at the one or more times determined by the scheduler, one or more instructions to take the one or more actions; and
a processor having a monitoring unit, the processor configured to take the one or more actions on the given message in response to the monitoring unit receiving the one or more instructions and in accordance with the one or more instructions received;
wherein the one or more actions are any one or combination of:
action I, send the message once immediately;
action II, send the message once at a first later time;
action III, send the message at a first series of recurring times starting immediately;
action IV, send the message at a second series of recurring times starting at a second later time;
action V, send the message at a time when the rate is lowest;
action VI, cancel the sending of the message;
action VII, provide to the user a first reminder at a third later time; and
action VIII, provide to the user a second reminder at a third series of recurring times starting at a fourth later time,
wherein action VI is not taken on the given message if any other action is taken.
